(19) United States
(12) Patent Application Publication
(10) Pub. No.: US 2019/0161930 A1
(43) Pub. Date: May 30, 2019

(54) STABILIZED WATER FLOW CONTROL GROUND COVER

(71) Applicant: Watershed Geosynthetics LLC, Alpharetta, GA (US)

(72) Inventors: Bradford H. Cooley, Chattanooga, TN (US); Michael R. Ayers, Johns Creek, GA (US)

(73) Assignee: Watershed Geosynthetics LLC, Alpharetta, GA (US)

(21) Appl. No.: 16/203,442

(22) Filed: Nov. 28, 2018

Related U.S. Application Data
(60) Provisional application No. 62/591,428, filed on Nov. 28, 2017.

(51) Int. Cl. E02B 3/12; B32B 5/26; B32B 27/32; B32B 5/06; D04H 1/4374; D04H 1/58

(52) U.S. Cl. CPC E02B 3/126; B32B 5/26; B32B 27/32; B32B 2250/02; D04H 1/4374; D04H 1/58; B32B 2250/20; B32B 5/06

(57) ABSTRACT

A non-woven mat of randomly oriented thermoplastic or polymeric fibers defining interstitial gaps that form interference pathways for non-direct water flow therethrough, whereby the mat being disposed on a ground surface moderates a rate of flow of environmental water for increased seepage of the environmental water into a subground and resists rapid lateral flow of environmental water across the ground cover, and with a stabilization layer in a bottom surface portion of the mat or optionally secured with staples to the ground. A method of forming a stabilized water flow control ground cover is disclosed.

### CROSS-REFERENCE TO RELATED APPLICATIONS

The present application claims benefit of U.S. Provisional Patent Application Ser. No. 62/591,428 filed Nov. 28, 2017, incorporated herein in its entirety by reference.

### TECHNICAL FIELD

This invention relates generally to ground covers and methods used in covering large areas of ground for controlling environmental water infiltration into covered ground and/or wind erosion of the ground surface. More particularly, the present invention relates to ground covers that regulate flow of environmental water covering large areas of ground through the ground cover for abated infiltration through the ground cover into a ground water table below and methods for abated infiltration of environmental water for replenishing the ground water table. The invention further provides for control of dust scattering in response to wind forces on a ground surface.

In this application, the following terms will be understood to have the indicated definitions.

“tufted geosynthetics”—a cover system which is generally comprised of synthetic grass having synthetic fibers tufted to a backing and a geomembrane and which is adapted to cover waste sites and other environmental closures. Examples of a tufted geosynthetic cover system are shown in Ayers and Urrutia U.S. Pat. Nos. 7,682,105 and 9,163,375. The term “tufted geosynthetics” is also used to refer to a synthetic turf cover system.

“synthetic grass”—refers to a composite which comprises at least one geotextile (woven or nonwoven) tufted with one or more synthetic yarns or strands and which has the appearance of grass.

“sloping ground”—refers to ground which is not level, but has an angle of slope.

“environmental water”—refers to water occurring at a landsite, such as rainfall, snow melt, and storm water runoff.

“nonwoven textile” or “nonwoven mat” refers to fabric, sheet or web structures bonded together by entangling fiber or filaments (and by perforating films) mechanically, thermally, solvent or chemically, which structures are flat or tufted porous sheets or fabric-like materials made directly from separate staple fibers (short) and long fibers (continuous long) of polymeric materials, molten plastic or plastic film, held together by chemical, mechanical, heat, or solvent treatment.

### BACKGROUND OF THE INVENTION

Coverings have been used to overlay large areas of ground including landfills, waste sites, manufacturing laydown sites, and stockpiles. Some tufted geosynthetic ground covers are used to shed environmental water and prevent the water from infiltration through the site and being absorbed into the soil which may allow contaminates into the soil. Other sites such as in arid regions experience infrequent, but short duration rain storms. Often the rain storms are intense with significant volume of rainfall water. A common problem with such rainfall in arid regions is the rapid accumulation of large amounts of water that results in large volumes of water moving swiftly and rapidly across the ground particularly across the slopes and into gullies, stream beds, or ravines often present in such areas. The large volume flow and velocity of environmental water that may occur from sudden and heavy rainfall poses a danger to persons in low areas and areas remotely downstream from the source rainfall, and may cause damage to the ground as the fast moving water moves across the ground. Further the fast moving water fails to substantially infiltrate the ground and replenish the local ground water table, but rather a significant volume of the available environmental water often moves rapidly away through stream beds and to locations remotely downstream. Much of the available environmental water thus fails to enter the local ground water table.

Also, arid regions typically have insufficient plants, grasses, bushes, and trees, for resisting erosion by wind dispersion of soils and dust particles. Such wind-blown materials erode ground surfaces and cause dusty air conditions.

While water-shedding ground covers accordingly allow clean water to flow-off of the covered site and also provide control of wind-caused erosion, there are reasons to allow infiltration of environmental water for absorption into the underlying soil. However, the tufted geosynthetic types of ground covers are expensive to manufacture, install, and maintain.

Accordingly, it is seen that a need remains for a ground cover which may be formed to slow or abate environmental water flow across a ground for moderated flow allowing absorption of the water into the local source soil and ground water table below and control dusts, yet is easy and cost effective to manufacture, install, and maintain. It is to the provision of such that the present invention is directed.

### SUMMARY OF THE INVENTION

The present invention meets the need in the art for a stabilized water control ground cover providing environmental water flow abatement and wind erosion control over land surfaces for local source infiltration into ground water table. In one aspect, the present invention meets the need in the art by providing for stabilized water flow control ground cover of a non-woven mat of randomly oriented thermoplastic or polymeric fibers defining interstitial gaps and the mat having respective extended longitudinal and transverse axis and a thickness that is less than an significant minority of the transverse axis. The interstitial gaps define a plurality of interference pathways for non-direct water flow through the mat. The mat being disposed on a ground surface moderates a rate of flow of environmental water for increased seepage of the environmental water into a subground and resists rapid lateral flow thereof across the ground surface.

In yet another aspect, the present invention provides a method of abating environmental water flow off of a ground surface, comprising the steps of:

(a) forming an elongated non-woven mat of randomly oriented thermoplastic or polymeric fibers to define a plurality interstitial gaps providing a plurality of interference pathways for non-direct water flow therethrough; and

(b) disposing the mat over a ground surface,

whereby the mat upon exposure to a flow of environmental water, moderates the rate of water for increased seepage of the water though the mat into a subground while resisting rapid lateral flow of the water across the ground surface.

In yet another aspect, the present invention meets the need in the art by providing a stabilized environmental water flow control ground cover of a non-woven mat of randomly oriented thermoplastic or polymeric fibers defining interstitial gaps and the mat having respective extended longitudinal and transverse axis and a thickness that is less than an significant minority of the transverse axis. The interstitial gaps defining a plurality of interference pathways for non-direct water flow through the mat. A stabilization layer in a surface portion of the mat has a plurality of contacting engagements of portions of at least some of the fibers, whereby the mat is stiffened. The mat being disposed over a ground surface moderates a rate of flow of environmental water for increased seepage of the environmental water through the interference pathways into a subground and resists rapid lateral flow of the environmental water across the ground surface.

In another aspect briefly described, the present invention provides a new and improved stabilized water flow control ground cover for use in conjunction with large areas of land, such as a ground cover comprising a non-woven layer or mat of randomly oriented thermoplastic or polymeric fibers tufted with a synthetic yarn to form a plurality of spaced-apart tufts of blades extending from an upper surface and joined in a bottom surface by tuft bridges, with the bottom surface stabilized by heat bonding both some of the fibers and the tuft bridges at and proximate the bottom surface of the mat for providing a porous or water permeable tufted stabilized water control ground cover featuring the synthetic grass-like blades.

Objects, advantages, and features of the present invention will become apparent upon a reading of the following detailed description in conjunction with the drawings and the appended claims.

### BRIEF DESCRIPTION OF THE DRAWINGS

FIG. 1 illustrates in a perspective view of a bottom of a stabilized water flow ground cover in accordance with the present invention.

FIG. 2 illustrates in a perspective view of the stabilized water flow ground cover illustrated in FIG. 1.

FIG. 3 illustrates in perspective view an application of the stabilized water flow ground cover shown in FIG. 1 to a land area subject to environmental water source occurrences for abated flow and infiltration of environmental water to replenish a ground water table.

FIG. 4 illustrates in perspective view an alternate embodiment of a stabilized ground cover in accordance with the present invention overlaid on a ground surface for dust control.

### DETAILED DESCRIPTION

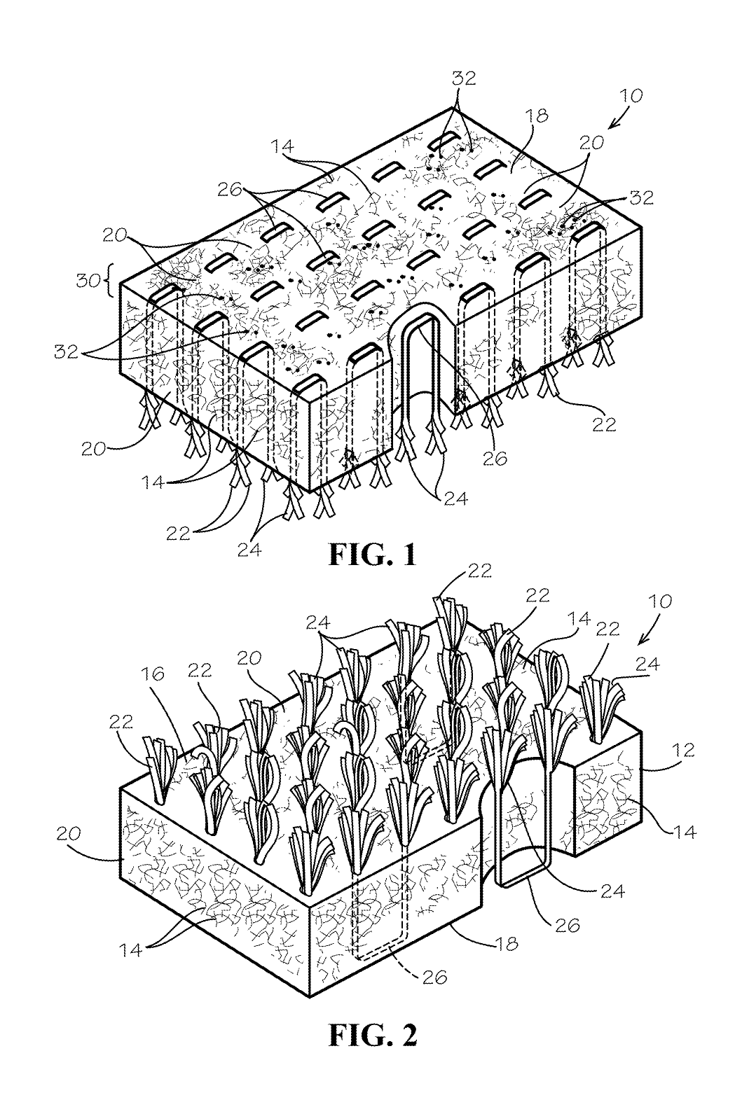

With reference next to the drawings, there is shown in FIG. 1 in perspective bottom view a ground cover 10 embodying principles of the invention in a preferred form. The ground cover 10 has a non-woven textile layer or mat 12 of randomly oriented polymeric fibers 14 (sometimes referenced herein as thermoplastic fibers), which may be made of polyethylene, polypropylene, polyolefin, or other non-woven textile fiber, spun-bond or lofted/air laid as a non-woven textile. The mat 12 has respective extended longitudinal and transverse axis and a thickness that is less than an significant minority of the transverse axis. That is, the thickness is less than the width. The mat 12 has an upper side 16 and opposing bottom side 18. The fibers 14 define a plurality of interstitial gaps or spaces 20. The spaces 20 formed by the fibers 14 define interference pathways for flow of environmental water through the mat 12. The fibers 14 interfere with direct linear flow, and rather, the environmental water flows in non-linear, not-direct channels downwardly and laterally through and the mat.

Generally, the mat 12 features permittivity that allows abated water flow therethrough for infiltration of environmental water such as from a rain storm 25 local to a source occurrence for replenishing a ground water table. The term “permittivity” refers to a cross-plane permeability of water flow perpendicular to a plane of the mat 12 divided by the thickness of the textile under a normal load. See Designing with Geosynthetics by Dr. Robert Koerner (2012).

Presently, it is believed that mats 12 useful with the present invention are made according to the following properties:

Fiber denier (grams per 9000 meters) in a range from about 100 denier to about 15,000 denier.

An Apparent Opening Size (AOS): ASTM D4751 for AOS in a range from US Sieve size of 3 (6730 microns) to US Sieve size of 30 (595 microns).

The resulting mat has a thickness in a range from about 0.1 inches (2.54 mm) to 4 inches (101.6 mm).

The mass per unit area of the mat 12: 3 oz/square yd (85 grams/yd²) to 60 oz/square yd (1,700 grams/yd²).

With continuing reference to FIG. 1, the ground cover 10 also includes an array or mass of synthetic blades 22 incorporated into and extending from the upper side of the mat 12 as a plurality of spaced-apart tufts 24. The ground cover 10 thereby comprises a configured embodiment of a tufted geosynthetic enabled for abated water flow through the mat 12 that contributes to infiltration of environmental water through the mat and absorption of the water in the soil for replenishment of a ground water table. The synthetic blades 22 may be formed by any conventional means such as tufting of yarns through the non-woven mat or weaving tufts or lines of tufts of synthetic fibers or yarn into the non-woven mat. The tufting involves knitting the yarns through the mat 12 with running tuft bridges 26 on the bottom side 18 as best illustrated in FIG. 2. The tufting thereby defines the adjacent tufts 24 in a field of spaced-apart tufts.

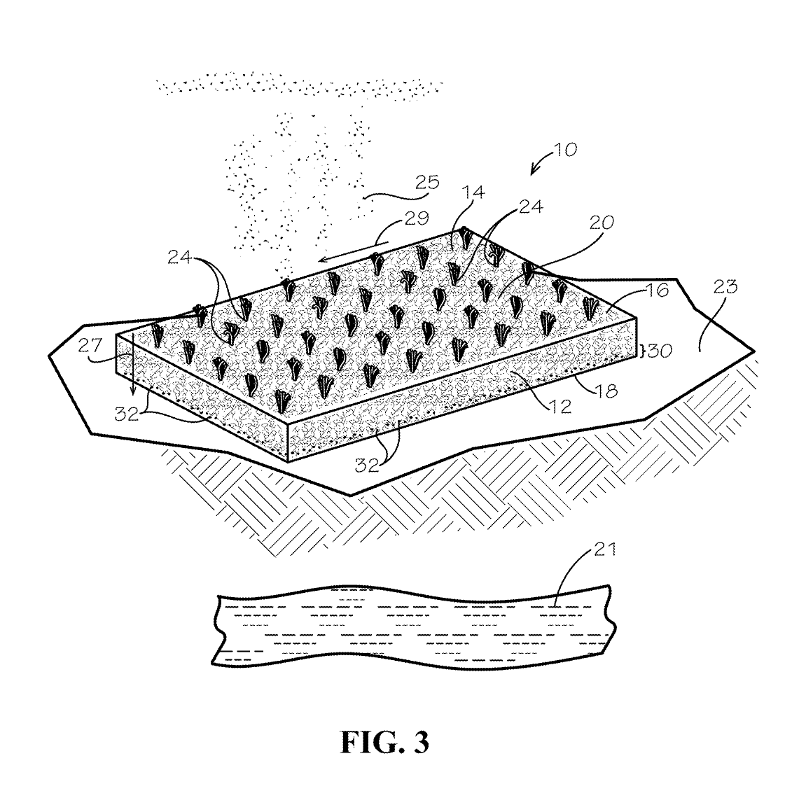

As discussed below, the spaces 20 during operational use of the ground cover 10 become occupied by environmental water and the combination of the randomly disposed fibers 14, the resulting spaces 20, and the tufts 24, cooperatively abate or moderate the flow of the environmental water through the mat 12 into a ground water table 21 below the ground surface 23 as shown in FIG. 3.

Preferably, the synthetic strands 22 are slender elongated elements. As used herein, “slender” indicates a length that is much greater than its transverse dimension(s). Examples of slender elongate elements contemplated as encompassed by the present invention or in conjunction therewith are structures that resemble blades of grass, rods, filaments, tufts, follicle-like elements, fibers, narrow cone-shaped elements, etc. The synthetic strands 22 extend upwardly from the base mat 12 as a field of such strands. Such can simulate a field of grass, pine straw or similar. The synthetic strands 22 extend upwardly a length of about ½ inch to about 4 inches.

Preferably, the chemical composition of the synthetic grass blades 22 should be selected to be heat-resistant and UV-resistant (to withstand exposure to sunlight, which generates heat in the blades and contains ultraviolet rays), and fire-retardant. Furthermore, the polymer yarns of the blades 22 should not become brittle when subjected to low temperatures. The selected synthetic grass color and texture should be aesthetically pleasing. While various other materials may work well for the grass blades, it is presently believed that polyethylene fibers work best.

Optionally, the synthetic grass blades 22 are tufted to have a density of between about 5 ounces/square yard and about 60 ounces/square yard. Preferably, the synthetic grass blades have a density of between about 10 and 40 ounces/square yard. The tufting is fairly homogeneous. In general, a “loop” is inserted at a gauge spacing to achieve the desired density. Each loop shows as two blades of grass at each tufted location. Preferably, the synthetic grass blades 22 have a thickness of at least about 50 microns.

The bottom side 18 of the mat 12 in the illustrated embodiment includes a stabilizer layer generally 30 in a side edge portion of the mat as illustrated in FIG. 1. The stabilizer layer 30 includes the bottom side 18 (and its open pore surface formed by the exterior portions of the fibers 14) and a proximate interior portion of the mat 12. The bottom side and proximate interior portions forming the stabilizer layer 30 comprises a minor dimension of the thickness of the mat 12. In the illustrated embodiment, the stabilizer layer 30 forms by contacting engagements 32 of portions of at least some of the fibers 14 and of portions of the fibers 14 and the tuft bridges 26 as tuft bind connections. The stabilization layer 30 stiffens the mat 12 with a bottom or lower portion of the mat 12 proximate the ground surface 23 providing a structural stabilization.

In the illustrated embodiment, the fibers 14 and fibers 14 and tuft bridges 26 heat bond together, or tuft bind, to establish the stabilizer layer 30. The structure of the stabilization layer 30 forms by heat-bonding respective overlapping fibers 14 in the mat 12 at points of contact 32, and by heat-bonding of the fibers 14 that are in contact (32) with the tuft bridges 26 that extend across portions of the bottom side of the mat 12. This is accomplished with a heat bond/calendar process in which the open lofted fabric of the air-laid fibers are heated and calendared to reduce or take downwardly the lofting of the mat. For example, a heated roller heats the fibers 14 of the bottom side 18 and proximate portion of the mat 12 and the tuft bridges 26 and calendars the heated fibers and tufted bridges while leaving the interstitial spaces 20 porously open for environmental water flow. The bottom side and proximate portion of the mat 12 thereby form the joined integral stabilizing structure 30 of the bottom ground-contacting portion of the mat 12. Other bonding such as adhesive, spray-upon polypropylene, polyethylene or polymerizing vinyl chloride (PVC), or the like, may contactingly engage the respective fibers and tuft bridges, while leaving generally open the pores defined by the fibers for permeability of the mat. The stabilizer portion 30 retains a base of the tufts 24 secured to the bottom side 18 and resists pull-out of the tufts and separation of the tufts from the mat 12 during long-term usage of the ground cover in exposure to wind, environmental water, and other weather related events, for ground cover longevity.

In reference to FIGS. 1 and 3, the ground cover 10 is positioned for use over or upon a tract of land wherein it is desired to have environmental water 25 such as rainfall, snow melt, or storm water runoff seep or infiltrate into the soil. As the water falls upon the ground cover 10, the water seeps, percolates or travels generally 27, 29 through the mat 12. The spaced fibers 14 and interstitial gaps or spaces 20 cooperatively abate or moderate the flow of the environmental water through the mat 12. While the environmental water flows generally downwardly 27 through the air-laid mat 12, the tufts 24 of the grass blades 22 abate the rapid lateral flow to a slower flow 29 across the ground cover 10. The tuft bind of the fibers 14 and the tuft bridges 26 creates drag on the water flow while the tufts remain secured in the stabilizer portion 30. The non-woven mat 12 thereby slows down the movement and the flow rate or rate of travel of the water through the mat (downwardly and laterally). This slows the flow of environmental water across, through and over the ground cover 10.

As a result, the environmental water has an increased dwell time relative to the ground cover 10. The invention thereby increases the capability of the environmental water on the ground cover to pass from the non-woven mat 12 outwardly of the stabilizer portion 30 and into the underlying soil for replenishment of the ground water table 21. The ground cover 10 thereby provides hydraulic energy dissipation for the overland flow of the water that does not infiltrate the ground. The energy dissipation results from the slowing of the environmental water which promotes infiltration and seepage. Slowing of the water flow further reduces the erosive forces (energy) below the ground cover and thereby reduces the potential for erosion rill or washout that, with water flow carrying away sediment, creates a recess below the ground cover. A recess formed below the ground cover results in a trampoline in that portion of the ground cover and the covered ground, and may lead to potential unstable ground particularly on slopes. The present invention thereby provides erosion dissipation across a large project site. Additionally, the non-woven mat 12 works very well in disturbing wind flow over the ground cover 10 and reducing the uplift forces upon the base layer 14.

The sizing of the pores or interstices 16 should be selected to allow the flow of water through the mat 12 and the stabilizing portion 30 by being large enough so as not to prevent the flow through the mat as a result of the water tension within the pores.

The synthetic grass ground cover 10 accordingly aids in abated slowing of the flow of water from environmental water such as rainfall while providing a pleasant appearance to the ground cover and providing a surface that creates turbulent air flow across the upper side which air flow applies a bearingly normal force against the mat 12 for resisting wind uplift.

In another aspect, the present invention provides a method for abated flow of environmental water flow over a ground surface for infiltration into the ground water table local to an environmental water occurrence particularly applicable for arid regions. The method provides the cover 10 comprising the mat 12 of air-laid fibers 14 tufted with yarn as the field of tufts 24 having the grass-like blades 22 with a stabilized portion 32 of the mat of joined fibers 14 and tuft bridges 26 in the bottom side of the mat 12, disposing the cover 10 over a large area of ground, for exposing to environmental water occurrences, in which the mat 12 abates the flow of environmental water to facilitate flow passage outwardly of the bottom side for infiltration into the local ground water table.

Further, the ground cover 10 in accordance with the invention suitably provides dust control or abatement features in addition to water flow control. The mat 12 formed of the air-laid fibers 12 define openings and passages generally 20 through the mat, with a thickness of about ¼ inch to about 3 inches. The mat 12 thereby provides constricted non-linear pores 20 or passageways as defined by the randomly laid fibers 14 relative to a perpendicular plane between the top side 16 and the bottom side 18. The fibers and the constricted non-linear pores 20 restrict passage of dust from the ground surface 23 in response to wind flow across the cover 10. It is contemplated that the textured upper side 16 creates a turbulent air flow proximate the cover 10 which air flow partially passes in the openings or passageways 20 in the mat 12, and thereby the fibers 14, the openings 20 through the mat 12, and the tufts 24, cooperatively resist outflow of dust from the ground surface through the mat 12. Further, as discussed above, the passages and pores defining the permittivity of the mat 12 abates environmental water flowing through the mat.

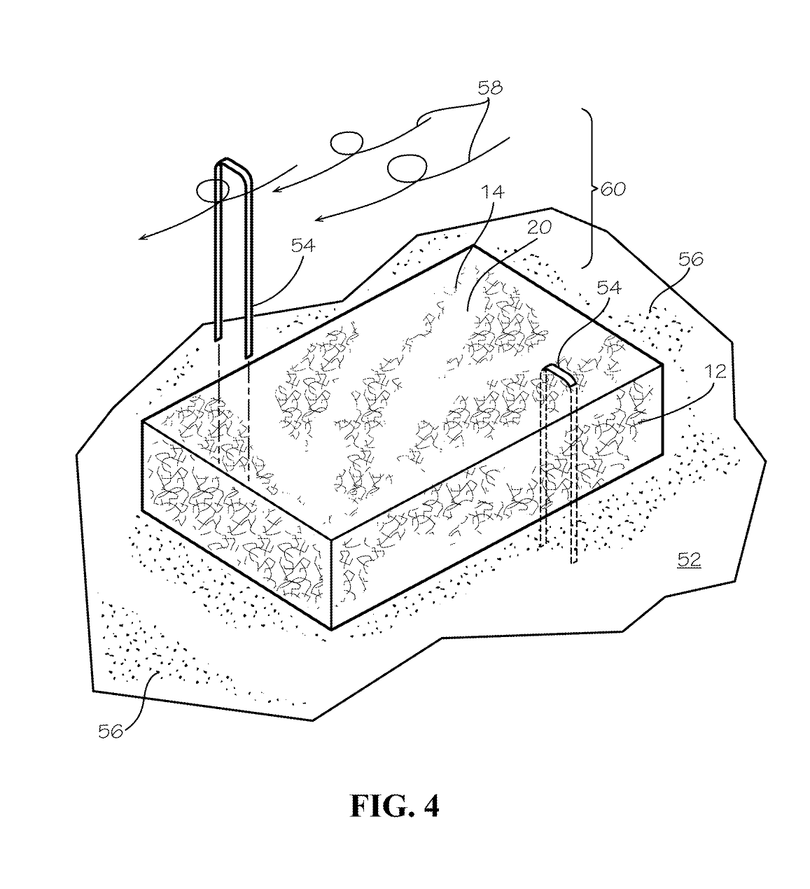

FIG. 4 illustrates in perspective view an alternate embodiment ground cover 50 overlaid on a ground surface 52 for dust control yet also providing water flow control, and resisting uplift from wind because of the weight of the mat 12 itself, or alternatively also optionally secured with staples 54 or similar ground securing fasteners. The ground cover 50 forms of the air-laid fibers 14. This alternate embodiment is particularly preferred for temporary application in a method of controlling uplift of surface materials as wind-carried dust within the air above a ground surface, deploying the mat 12 as a dust control ground cover overlying a ground surface 52 having exposed dust 56 but provided without the tufted yarns for tufts 24 of simulated grass and without the stabilized structure 30. The term “temporary application” refers to a period of time less than that specified conventionally for tufted geosynthetic cover systems for site closure purposes pursuant to regulatory guidelines and rules concerning closures for landfills, waste sites, and environmental sites requiring a geomembrane that restricts water infiltration and secured from wind uplift. The term “temporary application” in an illustrative embodiment refers to a period of up to and about 10 years, although the method of dust control matting may involve a longer period.

The ground cover 50 thereby provides an inexpensive, light-weight porous water flow control mat for covering large areas of wind-subject ground 52 while resisting uplift of dust 56 from the ground surface. Upon exposure to wind, the non-linear top side 16 creates a turbulent air flow generally 58 proximate 60 the cover 50 which air flow partially passes in the openings or passageways 20 in the mat 12, and thereby the fibers 14 and the openings 20 through the mat 12, cooperatively resist outflow of dust from the ground surface through the mat 12. The present invention accordingly provides a method for dust control of ground surfaces by seating the ground cover 50 as a blanket of the mat 12 in contact with the ground surface 52, and alternatively securing the blanket with anchors, U-shaped staples 54, pins, or other such mechanical connectors, to the ground, and alternatively, with the mass of the mat 12 and/or the turbulent proximate air flow, cooperatively resisting wind upload forces, and restricting flow of dust from the ground into the air by wind across the covered area. The blanket may comprise multiple side-by-side partially overlapping and edge joined lengths of the mat 12 (for example, mats 12 having a length of 12 feet supplied in rolls for unrolling installation on the ground surface and adjacent overlapped edges heat-bonded together to form the area wide blanket). The staples 54 provide lateral stabilization of the mat 12. The staples 54 may also optionally be gainfully employed with the ground cover 10 illustrated in FIG. 3.

The foregoing discloses embodiments of a ground cover that aids in slowing or abating the flow of environmental water over and through the ground cover while encouraging the seepage and infiltration of the water into the ground, suitable for arid regions, for replenishing ground water tables, and further, providing for a dust control for reducing airborne dust arising from wind passing over the ground as blocked or restricted by the ground cover in accordance with illustrative embodiments of the present invention. The foregoing discloses the construction of such ground cover apparatus and deployment of ground cover apparatus for water retention and infiltration with reduced airborne dust. The ground covers of the present invention are selectively constructed and arranged to meet specified performance characteristics for stabilization service life longevity and resistance to ultraviolet degradation. While this invention has been described with particular reference to certain embodiments, one of ordinary skill may appreciate that variations and modifications can be made without departing from the spirit and scope of the invention as recited in the appended claims.

What is claimed is:

1. A stabilized water flow control ground cover, comprising:
a non-woven mat of randomly oriented polymeric fibers defining interstitial gaps, the mat having respective extended longitudinal and transverse axis and a thickness that is less than an significant minority of the transverse axis,
the interstitial gaps defining a plurality of interference pathways for non-direct water flow therethrough,
whereby the mat being disposed on a ground surface moderates a rate of flow of environmental water for increased seepage of the environmental water into a subground and resists rapid lateral flow thereof across the ground surface.

2. The stabilized water flow control ground cover as recited in claim 1, wherein the mat exhibits high permittivity.

3. The stabilized water flow control ground cover as recited in claim 1, wherein the denier of the fibers is in a range of about 100 denier to about 15,000 denier.

4. The stabilized water flow control ground cover as recited in claim 1, wherein the mat provides an apparent opening size in a range from U.S. sieve size 3 to U.S. sieve size 30.

5. The stabilized water flow control ground cover as recited in claim 1, wherein the mat has a thickness in a range of about 0.1 inch to about 4.0 inches.

6. The stabilized water flow control ground cover as recited in claim 1, where in the mat has a mass per unit area of about 3 ounces per square yard to 60 ounces per square yard.

7. The stabilized water flow control ground cover as recited in claim 1, further comprising a plurality of spaced-apart tufts extending from an upper surface of the mat.

8. The stabilized water flow control ground cover as recited in claim 7, wherein the tufts are tufted with a polymeric yarn to form one or more synthetic blades in each tuft extending from the upper surface of the mat to a blade extent to simulate a field of grass.

9. The stabilized water flow control ground cover as recited in claim 8, wherein the yarn includes a UV-resistant component.

10. The stabilized water flow control ground cover as recited in claim 7, wherein the tufts are tufted for a density of about 5 ounces per square yard to about 60 ounces per square yard.

11. The stabilized water flow control ground cover as recited in claim 7, wherein the tufts have a length of about 0.5 inches to about 4 inches.

12. The stabilized water flow control ground cover as recited in claim 1, further comprising a stabilizer layer in a lower portion of the mat.

13. The stabilized water flow control ground cover as recited in claim 12, wherein the stabilizer layer comprises a minor thickness dimension of the mat.

14. The stabilized water flow control ground cover as recited in claim 12, wherein the stabilizer layer comprises a plurality of contacting engagements of portions of at least some of the fibers, whereby the mat is stiffened.

15. The stabilized water flow control ground cover as recited in claim 12, wherein the contacting engagements comprise adjacent contacting fibers heat-bonded together.

16. The stabilized water flow control ground cover as recited in claim 12, wherein the tufting disposes bridges across a bottom surface of the mat between adjacent tufts.

17. The stabilized water flow control ground cover as recited in claim 16, wherein the contacting engagements comprise heat bonded connecting of portions of a respective fiber and a respective one of the bridges.

18. The stabilized water flow control ground cover as recited in claim 17, wherein the contacting engagements of the respective fiber and the respective one of the bridges are heat bonded by calendaring of the mat between heated calendar rollers.

19. The stabilized water flow control ground cover as recited in claim 1, further comprising a plurality of staples for spaced-apart insertion through the mat disposed over a ground surface.

20. The stabilized water flow control ground cover as recited in claim 1, wherein upon disposing the mat over a ground surface, and upon exposure to wind, the open interstitial gaps in an upper surface forming in situ a turbulent flow field across the mat for resisting wind upload.

21. A method of abating water flow off of a ground surface, comprising the steps of:
(a) forming an elongated non-woven mat of randomly oriented polymeric fibers to define a plurality interstitial gaps providing a plurality of interference pathways for non-direct water flow therethrough; and
(b) disposing the mat over a ground surface,
whereby the mat upon exposure to a flow of environmental water, moderates the rate of water flow for increased seepage of the water though the mat into a subground while resisting rapid lateral flow of the water across the ground surface.

22. The method as recited in claim 21, wherein the mat exhibits high permittivity.

23. The method as recited in claim 21, wherein the step of forming the mat uses a fiber having a denier in a range of about 100 denier to about 15,000 denier.

24. The method as recited in claim 21, wherein the step of forming the mat forms the mat to have an apparent opening size in a range from U.S. sieve size 3 to U.S. sieve size 30.

25. The method as recited in claim 21, wherein the mat forms to have a thickness in a range of about 0.1 inch to about 4.0 inches.

26. The method as recited in claim 21, wherein the mat forms to have a mass per unit area of about 3 ounces per square yard to 60 ounces per square yard.

27. The method as recited in claim 21, further comprising a step of tufting a plurality of spaced-apart tufts extending from an upper surface of the mat.

28. The method as recited in claim 27, wherein the tufting uses a polymeric yarn to form one or more synthetic blades in each tuft extending from the upper surface of the mat to a blade extent to simulate a field of grass.

29. The method as recited in claim 28, wherein the yarn includes a UV-resistant component.

30. The method as recited in claim 27, wherein tufting step tufts the yarn to have tufts density of about 5 ounces per square yard to about 60 ounces per square yard.

31. The method as recited in claim 27, wherein the tufting forms tufts having a length of about 0.5 inches to about 4 inches.

32. The method as recited in claim 21, further comprising a step of forming a stabilizer layer in a lower portion of the mat.

33. The method as recited in claim 33, wherein forming the stabilizer layer comprises forming a plurality of contacting engagements of portions of at least some of the fibers.

34. The method as recited in claim 32, wherein forming the stabilizer layer comprises heat bonding adjacent fibers as the contacting engagements.

35. The method as recited in claim 27, wherein the tufting disposes bridges across a bottom surface of the mat between adjacent tufts; and wherein forming the stabilizer layer comprises heat bonding portions of a respective one of the fibers and a respective one of the bridges.

36. The method as recited in claim 35, wherein the respective fiber and the respective bridge heat bond by calendaring of the mat between heated calendar rollers.

37. The method as recited in claim 21, further comprising a step of securing the disposed mat to the ground surface by positioning a plurality of staples in spaced-apart relation inserted through the mat into a subground below the ground surface.

38. The method as recited in claim 37, wherein upon disposing the mat over a ground surface, and upon exposure to wind, the open interstitial gaps in an upper surface forming in situ a turbulent flow field across the mat for resisting wind upload.

39. A stabilized environmental water flow control ground cover, comprising:
a non-woven mat of randomly oriented polymeric fibers defining interstitial gaps, the mat having respective extended longitudinal and transverse axis and a thickness that is less than an significant minority of the transverse axis,
the interstitial gaps defining a plurality of interference pathways for non-direct water flow through the mat;
a stabilization layer in a surface portion of the mat comprising a plurality of contacting engagements of portions of at least some of the fibers, whereby the mat is stiffened,
whereby the mat being disposed over a ground surface moderates a rate of flow of environmental water for increased seepage of the environmental water through the interference pathways into a subground and resists rapid lateral flow of the environmental water across the ground surface.

40. The stabilized water flow control ground cover as recited in claim 38, further comprising a plurality of spaced-apart tufts extending from the upper surface of the mat to simulate a field of grass blades.
